(19) United States
(12) Patent Application Publication
(10) Pub. No.: US 2012/0193306 A1
(43) Pub. Date: Aug. 2, 2012

(54) METHOD AND SYSTEM FOR SOLVENT PURIFICATION

(76) Inventors: Ronald S. Hood, Hawthorne, CA (US); Melvin W. Hughes, Rancho Palos Verdes, CA (US)

(21) Appl. No.: 13/357,516

(22) Filed: Jan. 24, 2012

Related U.S. Application Data
(60) Provisional application No. 61/437,465, filed on Jan. 28, 2011.

(51) Int. Cl. B01D 33/72; B01D 37/00

(52) U.S. Cl. 210/781; 210/359; 210/360.1; 210/780

(57) ABSTRACT

A system and method for filtering solvent including a housing for receiving the solvent and a filtering media, where the solvent is moved through the filtering media without using a pump.

### CROSS-REFERENCE TO RELATED APPLICATION

This application is based upon and claims priority on U.S. Provisional Patent Application Ser. No. 61/437,465, filed on Jan. 28, 2011, the contents of which are fully incorporated herein by reference.

### BACKGROUND OF THE INVENTION

The present invention is directed to a method and a system for solvent purification. Synthetic and organo-metallic chemistry for example requires very high purity solvents. More specifically, synthetic chemistry requires solvents which are nearly deplete of oxygen and moisture content. Organo-metallic chemistry requires solvents which even have a higher purity as to moisture content. In other words, the solvent needs to be “dry” before it can be used.

A traditional method for purifying or “drying out” solvents is thermal distillation. Because solvents are very volatile, thermal distillation presents a significant fire and explosion hazard. In addition, it is a very inefficient method for drying out the solvent. Typically, distillation involves use of a suitable drying agent. A typical drying agent may be Li, Na, K, CaH₂, and LiAlH₄. These drying agents are highly reactive and as such, are quite dangerous. Over the years, there have been many fires and explosions involving thermal distillations of solvents. Chemists characterize thermal distillation as one of the most dangerous routine procedures they perform. Moreover, the maintenance of distillation equipment and the quenching of the drying agents are very laborious.

Another purification method uses the so-called “Grubbs apparatus” which uses a very large solvent reservoir and alumina/catalyst columns to dry and de-oxygenate solvents to a desired level of purity, without using heat or water reactive drying agents. The Grubbs apparatus takes up a lot of laboratory and research space. The system uses a large storage drum holding 15-20 liters of solvent and purification columns or cylinders that are typically over 30 inches tall and have a diameter greater than 3 inches. Multiple columns are used and are connected in series. Each of the columns contains an activated filter media that removes contaminants from a solvent as it passes through the column. The solvent is passed only once through the columns to get filtered. By the time the solvent reaches the end of the last column, the solvent is sufficiently filtered.

Filling of the drum reservoir with a solvent typically occurs under a fume hood for the purpose of evacuating all hazardous solvent fumes. Solvents may be provided in 4 liter containers. Thus, multiple containers must be used to fill the drum. Solvents may also be provided in larger containers, as for example 10 or 20 liter containers. Such containers are typically heavy. Moreover, it may be difficult or impossible to empty such containers into the drum reservoir while under a fume hood.

Furthermore, after use, each of the long columns must be regenerated, i.e., the contaminants which had been filtered out from the solvent must be removed from the columns. This may be quite difficult as the cylinders are long. The problem with the Grubb system is that it is not portable and, due to its size, it is confined to the space upon where the system is housed.

Moreover, the current systems typically can not be used to purify a small volume of solvent as the small volume of solvent would be taken up by the filtering media. In other words, a substantial volume of the solvent will wet the filtering media and will not be filtered. Thus, large volumes of solvent, as for example four liters or more, are required for being filtered with current systems. This may be undesirable in cases where only a very small amount of solvent is required for the task at hand.

### SUMMARY OF THE INVENTION

In an exemplary embodiment, a solvent filtering system is provided including a housing, a filtering media within the housing, an inlet for receiving a solvent, and a mechanism for moving the housing, causing the solvent to travel through the filtering media in order to filter the solvent. In one exemplary embodiment, the housing is seesawed about a pivot axis. In another exemplary embodiment, the housing is rotated about a pivot axis. In yet another exemplary embodiment, the housing defines a loop and the housing is rotated about the pivot axis, causing the solvent to travel through the filtering media. In a further exemplary embodiment, the housing defines a generally rectangular loop. In yet a further exemplary embodiment, the housing defines a generally circular loop. In another exemplary embodiment, the housing is tubular. In one exemplary embodiment, the filtering media occupies a section of the housing. In another exemplary embodiment, the filtering media includes a moisture removing media. In yet another exemplary embodiment, the filtering media includes an oxygen removing media. In a further exemplary embodiment, the system is capable of filtering 50 ml or less of solvent.

In another exemplary embodiment, a method for filtering a solvent is provided. The method includes introducing a solvent into a housing including a filtering media, and moving the housing, causing the solvent to repeatedly flow through the filtering media. In a further exemplary embodiment, moving includes rocking the housing about an axis. In yet another exemplary embodiment, moving includes rotating the housing about an axis. In yet a further exemplary embodiment, the housing is tubular. In one exemplary embodiment, the housing is generally rectangular. In yet another exemplary embodiment, the housing is generally circular. In a further exemplary embodiment, moving the housing includes moving the housing for a pre-determined amount of time for obtaining a desired level of solvent purity. In yet another exemplary embodiment, the filtering media includes a moisture removing media. In a further exemplary embodiment, the filtering media includes an oxygen removing media. In yet a further exemplary embodiment, the method also includes introducing 50 ml or less of solvent.

In a further exemplary embodiment, a solvent filtering system is provided including a housing, a filtering media within the housing, an inlet for receiving a solvent, and a mechanism for moving the filtering media relative to the housing, causing the solvent to travel through the filtering media in order to filter the solvent. In yet a further exemplary embodiment, the filtering media includes a moisture removing media. In another exemplary embodiment, the filtering media includes an oxygen removing media. In yet another exemplary embodiment, the system is capable of filtering 50 ml or less of solvent.

In one exemplary embodiment, a method for filtering a solvent is provided including introducing a solvent into a housing including a filtering media, and moving the filtering media within the housing, causing the solvent to repeatedly flow through the filtering media. In another exemplary embodiment, moving the filtering media includes moving the filtering media for a pre-determined amount of time in order to obtain a desired level of solvent purity. In yet another exemplary embodiment, the filtering media includes a moisture removing media. In a further exemplary embodiment, the filtering media includes an oxygen removing media. In yet a further exemplary embodiment, the method includes introducing 50 ml or less of solvent.

Each of the aforementioned embodiment systems and methods can filter the solvent without incorporating a pump for pumping the solvent, causing it to travel through the filtering medium. In another exemplary embodiment, a method for filtering solvent is provided. The method includes introducing a solvent into a housing including a filtering media, and repeatedly moving the solvent relative to a filtering media without pumping the solvent through the filtering media.

### BRIEF DESCRIPTION OF THE DRAWINGS

FIG. 1 is a plan view of an exemplary embodiment system of the present invention.

FIG. 2 is a plan view of another exemplary embodiment system of the present invention.

FIG. 3 is a plan view of yet another exemplary embodiment system of the present invention.

FIG. 4 is a partial cross-section view of another exemplary embodiment system of the present invention.

FIG. 5 is a top view of the filter housing used with the exemplary embodiment system shown in FIG. 4.

### DETAILED DESCRIPTION OF THE INVENTION

The system of the present invention may be made small enough for filtering four or less liters of solvent. In one exemplary embodiment, the system includes a filter housing, referred to herein as a “capsule” for convenience, which is small enough to filter less than one liter of solvent. For example, the capsule may be made small enough to filter 20 to 30 milliliters of solvent. Such a small volume of solvent can not be filtered with the conventional systems as the small volume of solvent would be just enough to wet the filtering media such that only a small or no amount of solvent will pass through the filtering media.

In one exemplary embodiment, as shown in FIG. 1, a capsule 10 is provided which houses a filtering media 12. End caps are mounted at the ends of the capsules. In an exemplary embodiment, the end caps are such that one can fill them with the solvent to be filtered. The end caps with solvent are then connected typically through a threading engagement to the capsule. The capsule is seesawed (i.e., rocked) back and forth about a pivot axis 16 causing the solvent to travel back and forth through the filtering media 12. The capsule is seesawed for an amount of time to obtain the desired level of solvent purity, e.g., to obtain a desired level of moisture content. Instead of the shown end caps, the capsule may be provided with an inlet for receiving the solvent at any location and has means for capping such inlet.

In another exemplary embodiment, the capsule may be continuously rotated (instead of seesawing back and forth) about the pivot axis 16. Rotation of the capsule is maintained for an amount of time to obtain a desired level of solvent purity.

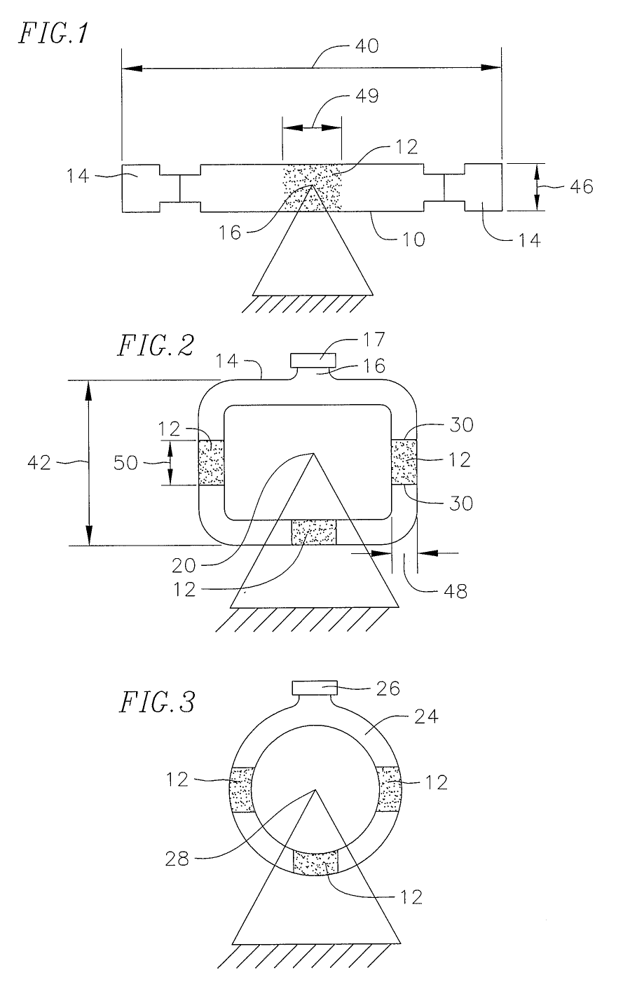

In another exemplary embodiment, as shown in FIG. 2, the solvent is placed into a generally square or rectangular capsule 14, (i.e., the capsule defines a generally square or rectangular loop) which includes a filtering media 12. The solvent is poured in the capsule through an inlet opening 16 which is afterwards capped with a cap 17 or other means. The capsule is then rotated about an axis 20 causing the solvent to travel through the media. Again, rotation of the capsule is maintained for an amount of time to obtain a desired level of solvent purity.

In yet another exemplary embodiment as shown in FIG. 3, the capsule 24 is generally circular in nature in that it generally defines a ring and has a capped opening 26 for receiving a solvent. The circular capsule is rotated about an axis 28 for a specified amount of time causing the solvent to travel through the filtering medium to obtain a specified level of purity. In other exemplary embodiments, the capsules may have other shapes, as for example triangular or oval.

In each of the above-identified embodiments, the filtering media may be placed in a single location within the capsule, or in more than one locations, as for example shown in FIGS. 2 and 3. Moreover, each of the capsules may be made in multiple sections that are connected together, as for example by threading, such that sections may be separated to allow for the placement of the filtering media at the appropriate locations. In some exemplary embodiments, the filtering media may be pre-packaged in a perforated housing which may be made from fabric or other porous material, which is sufficient to retain the filtering media while allowing for penetration by the solvent. The pre-packaged filtering media may be inserted into the appropriate locations within the capsules. In other exemplary embodiment, the filtering media may be held in place in the capsule using perforated end plugs, as for example perforated end plugs 30 as shown in FIG. 2.

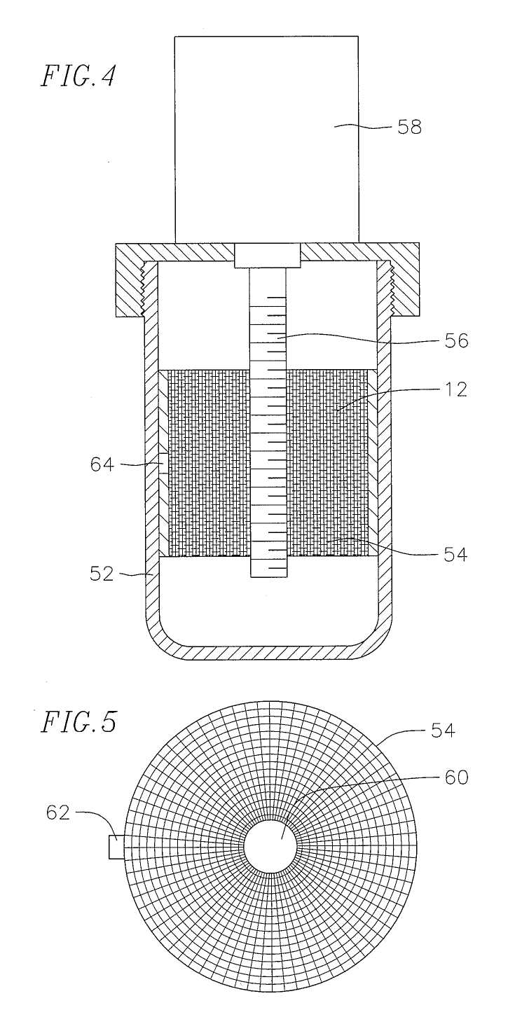

In another exemplary embodiment as shown in FIG. 4, the filtering media is moved within a capsule 52 and thus through and relative to the solvent being filtered. In the shown exemplary embodiment, the filtering media is retained within a porous (e.g. perforated) basket (also referred to herein as a “filter housing”) 54 that is coupled to a screw 56 driven by a mechanism 58. In one exemplary embodiment, the screw is powered by the drive mechanism to move toward and away from the drive mechanism and thus, translate the filtering basket with the filtering media along the capsule. In another exemplary embodiment, the filter basket 54 is an annular basket with an threaded opening 60 formed there through its center, as for example shown in FIG. 5. The screw 56 is threaded to the opening, as for example shown in FIG. 4. One or more stops 62 extending from the filter basket 54 engage corresponding stop(s) 64 extending within the capsule from the capsule body. As the screw 56 is rotated by the mechanism is a first direction, the stops prevent the filter basket from rotating in such direction and the filter basket is caused to translate in a first direction along the screw. As the mechanism reverses the screw rotation, the stops again prevent the rotation of the screw in the opposite direction and thus, cause the filter basket to translate in a second direction opposite the first direction along the screw. The basket may initially rotate until the stops engage.

In one exemplary embodiment, the filtering media is a media that removes moisture from the solvent. An exemplary media is Molecular Sieve. An exemplary Molecular Sieve is marketed under the trademark MOLSIV® which is registered to UOP, A Honeywell Company.

The movement of the capsules or filtering media is caused by a mechanism which is not shown. The mechanism may include a motor for moving the capsule. In another exemplary embodiment, the mechanism may be manually operated. Furthermore, the capsules may be made very small, as for example to only handle about 50 milliliters or less of solvent. In other exemplary embodiments, the system may have a sufficient size for filtering up to four liters of solvent or even more than four liters of solvent. These systems provide an advantage in that multiple systems may be placed in a fume hood and moved or rotated for a desired amount of time to obtain a desired level of solvent purity. As can be seen with these embodiments, a pump is not required to pump the solvent through the filtering media. Rather, the fluid is moved through the media by movement of the filter capsule or housing itself or by movement of the filtering media relative to the housing.

The exemplary embodiment system may be made small enough for incorporation into a fume hood. For example, with the embodiment shown in FIG. 1, the capsule may have a length 40 of 400 mm or less, and in another exemplary embodiment 75 mm or less. The inner diameter 46 of the capsule may also be 25 mm or less, and in another exemplary embodiment may be 10 mm or less. In an exemplary embodiment such as the one shown in FIG. 2, the length 42 (i.e., the length of a side defined by the capsule) of the capsule may be 400 mm or less, and in an exemplary embodiment may be 75 mm or less with the inner diameter 48 of the capsule being 25 mm or less or even 10 mm or less. However, the size may be varied upwards or downwards from these exemplary embodiments for the task at hand and for the amount of solvent to be purified. In addition, the filtering media in an exemplary embodiment occupies the entire inner diameter and spans only a portion of the length of the capsule as necessary for sufficient filtering. For example, in an exemplary embodiment shown in FIG. 1, the capsule has a length of 375 mm and the filtering media occupies the entire inner diameter 46 of about 25 mm and spans a length 49 of about 75 mm. Similarly, in another exemplary embodiment, the length 42 of the capsule shown in FIG. 2 is approximately 175 mm on a side and has an inner diameter of about 10 mm, and the filtering media 12 occupies a length 50 of such side of the capsule of about 40 mm.

With the exemplary systems, the solvent may be filtered to a desired level of moisture by circulating the filter capsules, or by seesawing the filter capsules, or by moving the filtering media relative to the capsule for a period of time or for an amount of revolutions or strokes to obtain the desired purity. The desired purity may be measured by removing the solvent by using well known methods or techniques and measuring its purity. For given solvents of a given volume and using a given filtering media, the amount of time or circulation may be predetermined. In addition, an oxygen removing filtering media may also be incorporated into the capsules for removing oxygen from the solvent. Moreover, in other exemplary embodiments, the inventive system may be used to filter solvents that are used in fields other than organo-metallic chemistry. In yet a further exemplary embodiment, the filtering media may be any filtering media for removing any undesired component from the solvent. In other exemplary embodiments, different types of filtering media for removing the same or different types of components from the solvent may be placed at different locations in the capsule or at the same location in the capsule or may be mixed together prior to placing in the capsule.

Although the present invention has been described and illustrated with respect to exemplary embodiments, it is to be understood that it is not to be so limited, since changes and modifications may be made therein which are within the full intended scope of this invention as hereinafter claimed.

What is claimed is:

1. A solvent filtering system comprising:
a housing;
a filtering media within the housing;
an inlet for receiving a solvent; and
a mechanism for moving the housing for causing the solvent to travel through the filtering media for filtering the solvent.

2. The system as recited in claim 1, wherein the housing is seesawed about a pivot axis.

3. The system as recited in claim 1, wherein the housing is rotated about a pivot axis.

4. The system as recited in claim 3, wherein the housing defines a loop and wherein the housing is rotated about said pivot axis for causing the solvent to travel through the filtering media.

5. The system as recited in claim 4, wherein the housing is tubular.

6. The system as recited in claim 1, wherein the filtering media occupies a section of said housing.

7. The system as recited in claim 1, wherein the filtering media comprises a moisture removing media.

8. The system as recited in claim 1, wherein the filtering media comprises an oxygen removing media.

9. The system as recited in claim 1, wherein the system is capable of filtering 50 ml or less of solvent.

10. A method for filtering a solvent comprising:
introducing a solvent into a housing comprising a filtering media; and
moving said housing for causing said solvent to repeatedly flow through said filtering media.

11. The method as recited in claim 10, wherein moving comprises rocking the housing about an axis.

12. The method as recited in claim 10, wherein moving comprises rotating the housing about an axis.

13. The method as recited in claim 12, wherein the housing is tubular.

14. The method as recited in claim 13, wherein the housing is generally rectangular.

15. The method as recited in claim 13, wherein the housing is generally circular.

16. The method as recited in claim 10, wherein moving said housing comprises moving said housing for a pre-determined amount of time for obtaining a desired level of solvent purity.

17. The method as recited in claim 10, wherein said filtering media comprises a moisture removing media.

18. The method as recited in claim 10, wherein said filtering media comprises an oxygen removing media.

19. The method as recited in claim 10, comprising introducing 50 ml or less of solvent.

20. A solvent filtering system comprising:
a housing;
a filtering media within the housing;
an inlet for receiving a solvent; and
a mechanism for moving the filtering media relative to the housing for causing the solvent to travel through the filtering media for filtering the solvent.

21. The system as recited in claim 20, wherein the filtering media comprises a moisture removing media.

22. The method as recited in claim 20, wherein said filtering media comprises an oxygen removing media.

23. The system as recited in claim 20, wherein the system is capable of filtering 50 ml or less of solvent.

24. A method for filtering a solvent comprising:
introducing a solvent into a housing comprising a filtering media; and
moving said filtering media within the housing for causing said solvent to repeatedly flow through said filtering media.

25. The method as recited in claim 24, wherein moving said filtering media comprises moving said filtering media for a pre-determined amount of time for obtaining a desired level of solvent purity.

26. The method as recited in claim 24, wherein said filtering media comprises a moisture removing media.

27. The method as recited in claim 24, wherein said filtering media comprises an oxygen removing media.

28. The method as recited in claim 24, comprising introducing 50 ml or less of solvent.

29. A method for filtering the solvent comprising:
introducing a solvent into a housing comprising a filtering media; and
repeatedly moving said solvent relative to a filtering media without pumping said solvent through the filtering media.
